(19) United States
(12) Patent Application Publication
(10) Pub. No.: US 2020/0219435 A1
(43) Pub. Date: Jul. 9, 2020

(54) LIGHT-EMITTING DIODE DRIVING CIRCUIT, DRIVING METHOD, AND DISPLAY USING THE SAME

(71) Applicant: MIKRO MESA TECHNOLOGY CO., LTD., APIA (WS)

(72) Inventors: Shyh-Feng CHEN, Hsinchu County (TW); Li-Yi CHEN, Tainan City (TW)

(21) Appl. No.: 16/243,099

(22) Filed: Jan. 9, 2019

(51) Int. Cl. G09G 3/32

(52) U.S. Cl. CPC G09G 3/32; G09G 2320/043; G09G 2300/0809; G09G 2330/02

(57) ABSTRACT

A light-emitting diode driving circuit including a light emitting diode, a first driving circuit, and a second driving circuit is provided. The first driving circuit is configured to provide a first driving current to the light-emitting diode during a first time period. The second driving circuit is configured to provide a second driving current to the light-emitting diode during a second time period. The first driving circuit and the second driving circuit are electrically and separately connected to one end of the light-emitting diode, and the first time period does not overlap with the second time period.

### BACKGROUND

### Field of Invention

The present disclosure relates to a light-emitting diode driving circuit and driving method which enhance the reliability of driving circuits.

### Description of Related Art

The statements in this section merely provide background information related to the present disclosure and do not necessarily constitute prior art.

Flat panel display devices gradually replace a cathode ray tube (CRT) in the past decade because they may be light and thin. Flat panel display devices such as liquid crystal display (LCD) device, light emitting diode (LED) display device, organic light-emitting diode display (OLED) device and so on are becoming popular. In recent years, various kinds of modifications and improvements on those flat panel display devices are promoted. One of the important issues is the reliability of driving circuits for driving the light-emitting diode.

### SUMMARY

According to some embodiments of the present disclosure, a light-emitting diode driving circuit including a light emitting diode, a first driving circuit, and a second driving circuit is provided. The first driving circuit is configured to provide a first driving current to the light-emitting diode during a first time period. The second driving circuit is configured to provide a second driving current to the light-emitting diode during a second time period. The first driving circuit and the second driving circuit are electrically and separately connected to one end of the light-emitting diode, and the first time period does not overlap with the second time period.

According to some embodiments of the present disclosure, a driving method for a light-emitting diode driving circuit is provided. The method includes providing a first driving current to a light-emitting diode by a first driving circuit during a first time period, and providing a second driving current to the light-emitting diode by a second driving circuit during a second time period. The first driving circuit and the second driving circuit are two individual driving circuits, and the first time period and the second time period do not overlap with each other.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1A is a schematic diagram of a light-emitting diode driving circuit according to some embodiments of the present disclosure;

FIG. 1B is a schematic diagram of a light-emitting diode driving circuit according to some embodiments of the present disclosure;

FIG. 1C is a voltage versus time diagram of a light-emitting diode driving circuit according to some embodiments of the present disclosure;

FIG. 1D is a schematic diagram of a light-emitting diode driving circuit according to some embodiments of the present disclosure;

FIG. 1E is a schematic diagram of a light-emitting diode driving circuit according to some embodiments of the present disclosure;

FIG. 2 is a schematic diagram of a light-emitting diode driving circuit according to some embodiments of the present disclosure;

FIG. 3A is a flowchart of a driving method according to some embodiment of the present disclosure;

FIG. 3B is an operation set for a driving method according to some embodiment of the present disclosure;

FIG. 3C is an operation set for the driving method according to some embodiment of the present disclosure;

FIG. 4A is a schematic diagram of a light-emitting diode driving circuit according to some embodiments of the present disclosure;

FIG. 4B is a voltage versus time diagram of a light-emitting diode driving circuit according to some embodiments of the present disclosure;

FIG. 4C is an operation set for the driving method according to some embodiments of the present disclosure; and

FIG. 5 is a schematic top view of a light-emitting diode display according to some embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

In various embodiments, description is made with reference to figures. However, certain embodiments may be practiced without one or more of these specific details, or in combination with other known methods and configurations. In the following description, numerous specific details are set forth, such as specific configurations, dimensions, and processes, etc., in order to provide a thorough understanding of the present disclosure. In other instances, well-known semiconductor processes and manufacturing techniques have not been described in particular detail in order to not unnecessarily obscure the present disclosure. Reference throughout this specification to “one embodiment,” “an embodiment”, “some embodiments” or the like means that a particular feature, structure, configuration, or characteristic described in connection with the embodiment is included in at least one embodiment of the disclosure. Thus, the appearances of the phrase “in one embodiment,” “in an embodiment”, “according to some embodiments” or the like in various places throughout this specification are not necessarily referring to the same embodiment of the disclosure. Furthermore, the particular features, structures, configurations, or characteristics may be combined in any suitable manner in one or more embodiments.

Although most of terms described in the following disclosure use singular nouns, said terms may also be plural in accordance with figures or practical applications.

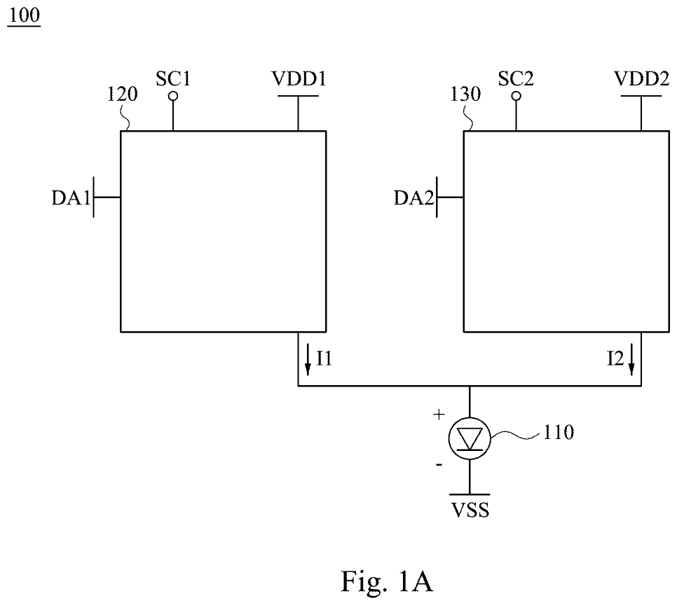

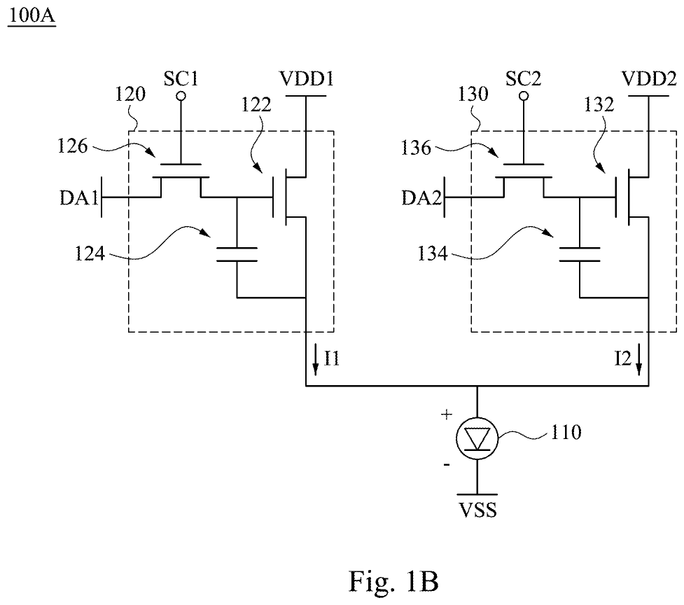

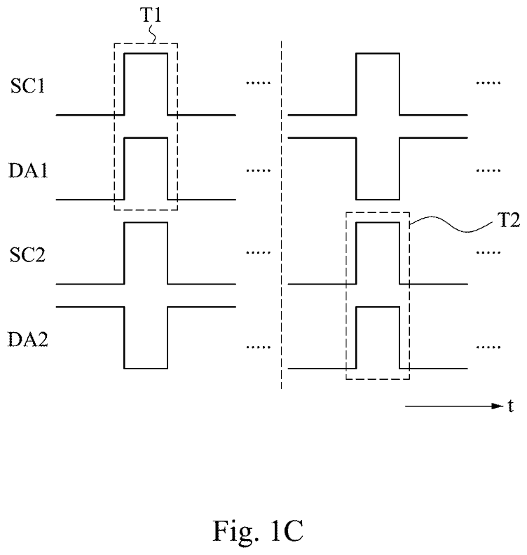

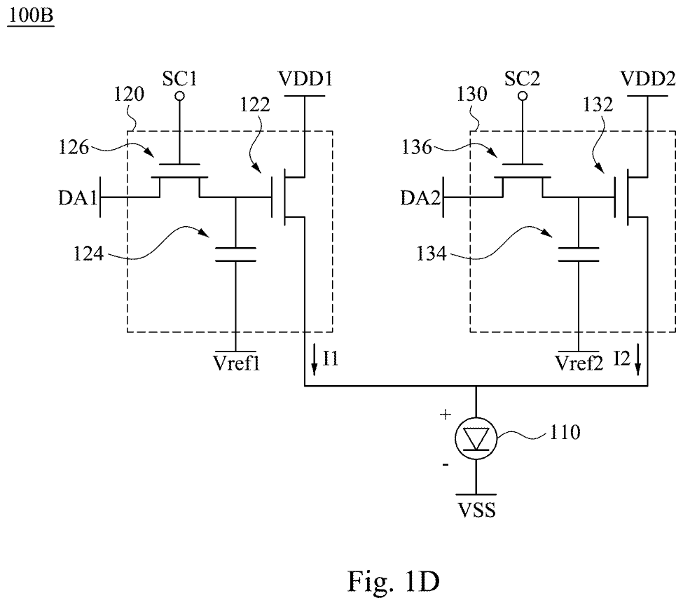

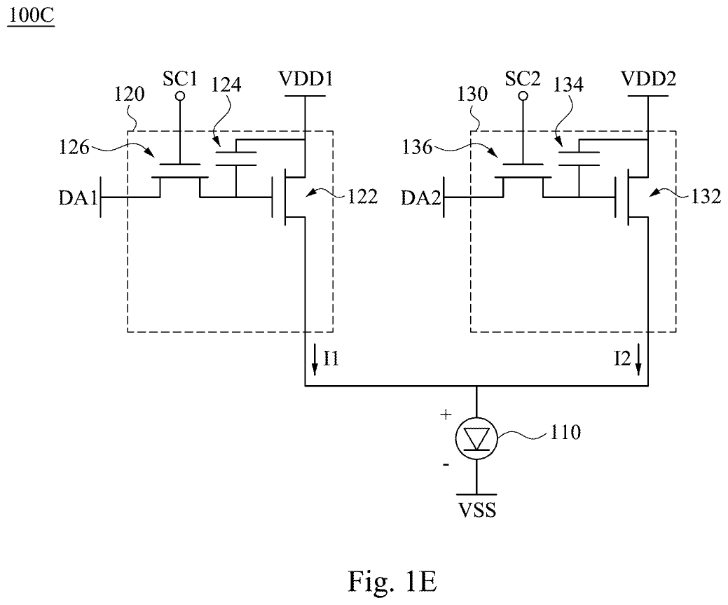

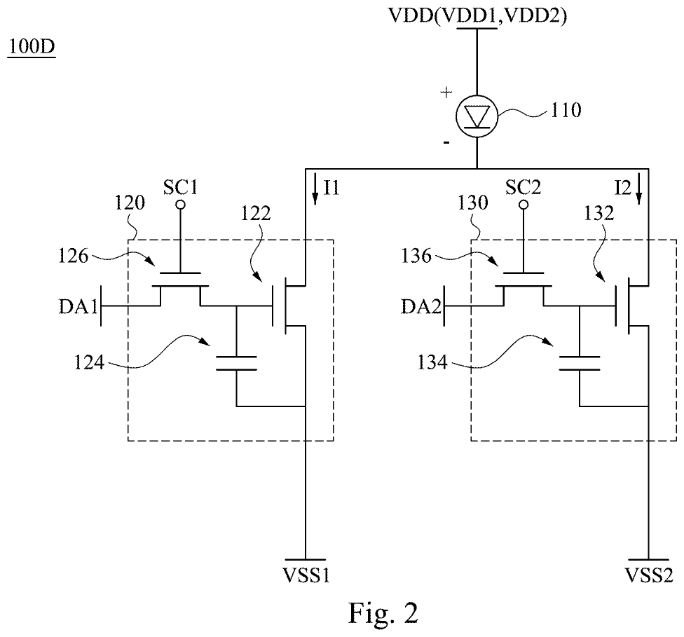

Reference is made to FIGS. 1A, 1B, 1C, and 2. FIG. 1A is a schematic diagram of a light-emitting diode driving circuit 100 according to some embodiments of the present disclosure. FIG. 1B is a schematic diagram of a light-emitting diode driving circuit 100A according to some embodiments of the present disclosure. FIG. 1C is a voltage versus time (denoted by t in a horizontal direction) diagram of the light-emitting diode driving circuit 100A according to some embodiments of the present disclosure. FIG. 2 is a schematic diagram of a light-emitting diode driving circuit 100D according to some embodiments of the present disclosure. In some embodiments, the light-emitting diode driving circuit 100 includes a light emitting diode 110, a first driving circuit 120, and a second driving circuit 130. The first driving circuit 120 is configured to provide a first driving current 11 to the light-emitting diode 110 during a first time period T1 according to voltages provided by a first scan line SC1, a first data line DA1, and a first driving voltage source VDD1. The second driving circuit 130 is configured to provide a second driving current 12 to the light-emitting diode 110 during a second time period T2 according to a second scan line SC2, a second data line DA2, and a second driving voltage source VDD2. The first driving circuit 120 and the second driving circuit 130 are electrically and separately connected to one end of the light-emitting diode 110. The “separately” herein means a path for a current flowing by the first driving circuit 120 to the light-emitting diode 110 and a path for a current flowing by the second driving circuit 130 to the light-emitting diode 110 are different two paths, and said two paths meet and join at the same end of the light-emitting diode 110. The first time period T1 does not overlap with the second time period T2, which means only one of the first driving circuit 120 and the second driving circuit 130 drives the light-emitting diode 110 at a given time (period). Therefore, the reliability of light-emitting diode driving circuit 100 can be enhanced since the first driving circuit 120 can have a rest during a time interval (or a time frame, as often used in the display field) when the light-emitting diode 110 is driven by the second driving circuit 130, and vice versa. It should be noted that more than two (e.g., three or four driving circuits) electrically and separately connected to the light-emitting diode 110 are also within the scope of the present disclosure.

In some embodiments, as the light-emitting driving circuit 100 in FIG. 1A shows, the light-emitting diode 110 has an anode and a cathode, the anode of the light-emitting diode 110 is configured to receive the first driving current 11 and the second driving current 12, and the cathode is connected to a low voltage source VSS. In some other embodiments, as the light-emitting driving circuit 100D in FIG. 2 shows, the cathode of the light-emitting diode 110 is electrically and separately connected (e.g., separately and directly connected) to the first driving circuit 120 and the second driving circuit 130.

Reference is made to FIGS. 1B and 2. In some embodiments as shown in FIG. 1B, the first driving circuit 120 includes a first driving transistor 122. The first driving transistor 122 has a gate terminal, a source terminal, and a drain terminal. The drain terminal of the first driving transistor 122 is configured to receive a first driving voltage from the first driving voltage source VDD1. Similar to the first driving transistor 122, the second driving transistor 132 also has a gate terminal, a source terminal, and a drain terminal thereof. The first driving transistor 122 and the second driving transistor 132 can be a thin film transistor (e.g., a hydrogenated amorphous silicon thin film transistor), a low-temperature poly-silicon (LTPS) transistor, indium gallium zinc oxide (IGZO), or a metal-oxide-semiconductor field effect transistor (MOSFET), but should not be limited thereto. For some p-type (e.g., LTPS) thin film transistors, the connection relationship among electronic elements in the light-emitting diode driving circuit (e.g., 100A, 100B, 100C, 100D or 100E) is substantially reversed and will not be described herein in detail. The drain terminal of the second driving transistor 132 is configured to receive a second driving voltage from the second driving voltage source VDD2. In some embodiments as shown in FIG. 1B, the anode of the light-emitting diode 110 is connected to the source terminal of the first driving transistor 122 and the source terminal of the second driving transistor 132. In some embodiments as shown in FIG. 2, which is an equivalent circuit as the embodiments of FIG. 1B, the anode of the light-emitting diode 110 is connected to a driving voltage source VDD. In these embodiments, the first driving voltage source VDD1 and the second driving voltage source VDD2 are connected to a junction, and are herein collectively referred to as “the driving voltage source VDD”. The cathode of the light-emitting diode 110 is electrically and separately connected (e.g., separately and directly connected) to the drain terminal of the first driving transistor 122 and the drain terminal of the second driving transistor 132. The source terminal of the first driving transistor 122 is electrically connected to a first low voltage source VSS1, and the source terminal of the second driving transistor 132 is electrically connected to a second low voltage source VSS2. In some embodiments, the first low voltage source VSS1 and the second low voltage source VSS2 have the same voltage level. In some other embodiments, the first low voltage source VSS1 and the second low voltage source VSS2 have different voltage levels.

Reference is made to FIGS. 1B, 1D, and 1E. FIG. 1D is a schematic diagram of a light-emitting diode driving circuit 100B according to some embodiments of the present disclosure. FIG. 1E is a schematic diagram of a light-emitting diode driving circuit 100C according to some embodiments of the present disclosure. According to some embodiments, the first driving circuit 120 and the second driving circuit 130 respectively include a first storage capacitor 124 and a second storage capacitor 134. The first storage capacitor 124 has two ends. One end of the first storage capacitor 124 is connected to the gate terminal of the first driving transistor 122, and another end of the first storage capacitor 124 is connected to the source terminal of the first driving transistor 122 (as shown in FIG. 1B), a first reference voltage Vref1 (as shown in FIG. 1D), or the first driving voltage source VDD1 (as shown in FIG. 1E). The second storage capacitor 134 has two ends. One end of the second storage capacitor 134 is connected to the gate terminal of the second driving transistor 132, and another end of the second storage capacitor 134 is connected to the source terminal of the second driving transistor 132 (as shown in FIG. 1B), a second reference voltage Vref2 (as shown in FIG. 1D), or the second driving voltage source VDD2 (as shown in FIG. 1E). The first reference voltage Vref1 and the second reference voltage Vref2 can be grounded or have the same voltage level as that of the low voltage source VSS, but should not be limited thereto. The storage capacitors 124, 134 are used to store voltage from the data lines DA1, DA2 respectively, and then serve as sources to provide gate voltages to the first driving transistor 122 and the second driving transistors 132 respectively.

In some embodiments, the first driving circuit 120 and the second driving circuit 130 respectively include a first switching transistor 126 and a second switching transistor 136. The first switching transistor 126 has a gate terminal connected to the first scan line SC1, a drain terminal connected to the first data line DA1, and a source terminal connected to one end of the first storage capacitor 124. The source terminal of the first switching transistor 126 is also connected to the gate terminal of the first driving transistor 122. The second switching transistor 136 has a gate terminal connected to the second scan line SC2, a drain terminal connected to the second data line DA2, and a source terminal connected to one end of the second storage capacitor 134. The source terminal of the second switching transistor 136 is also connected to the gate terminal of the second driving transistor 132. The first switching transistor 126 and the second switching transistor 136 are used to determine if voltages from the first data line DA1 and the second data line DA2 can be respectively applied to the gate terminal of the first driving transistor 122 and the gate terminal of the second driving transistor 132, so as to determine amounts of currents flowing through the first driving transistor 122 and the second driving transistor 132 respectively.

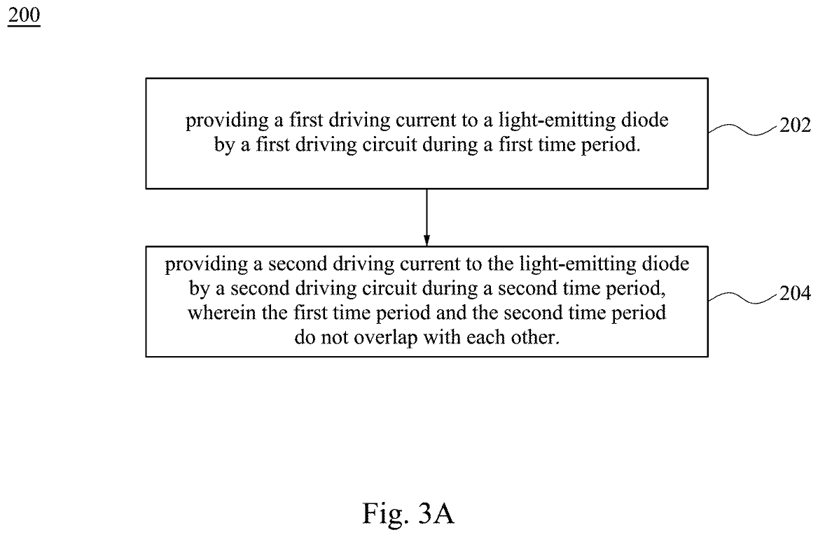

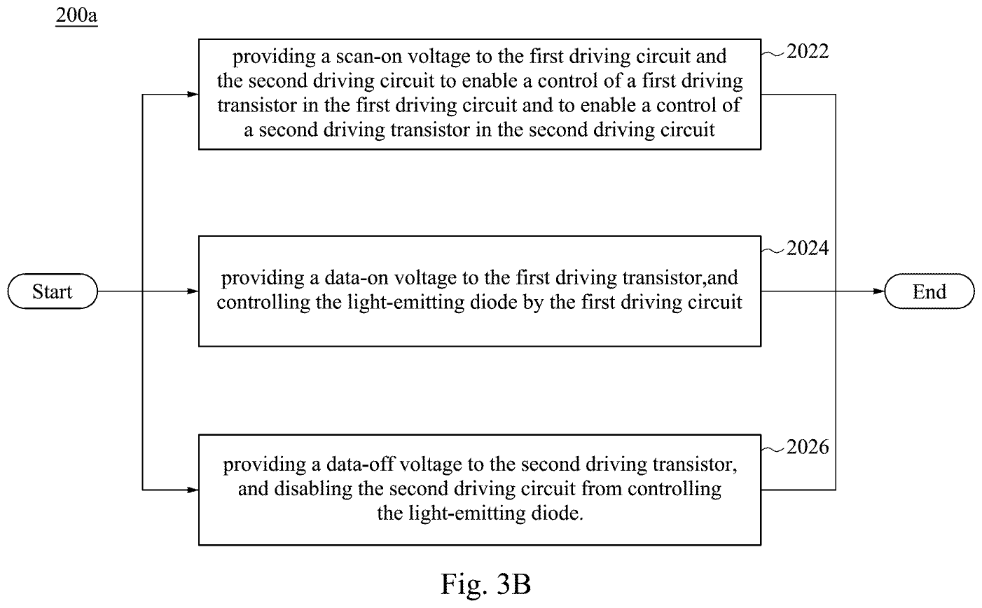

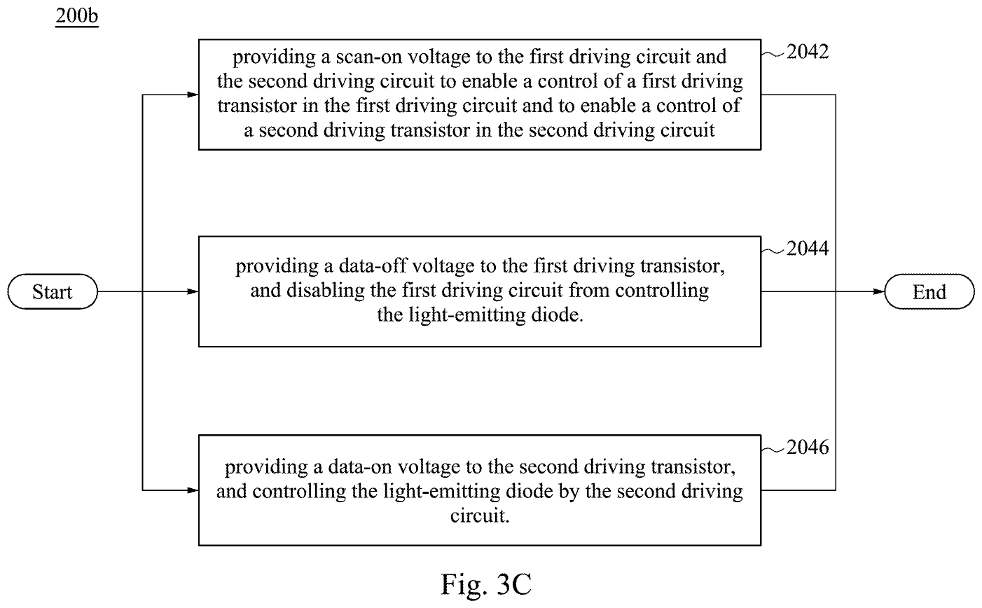

Reference is made to FIGS. 1A to 1D, FIG. 2, and FIG. 3A. FIG. 3A is a flowchart of a driving method 200 according to some embodiment of the present disclosure. In some embodiments, a driving method 200 for the light-emitting diode driving circuit 100 is provided. The driving method 200 begins with operation 202 in which the first driving current 11 is provided to the light-emitting diode 110 by the first driving circuit 120 during the first time period T1 (as shown in FIG. 1C). The driving method 200 continues with operation 204 in which the second driving current 12 is provided to the light-emitting diode 110 by the second driving circuit 130 during the second time period T2 (as shown in FIG. 1C). In these embodiments, the first driving circuit 120 and the second driving circuit 130 are two individual driving circuits, and the first time period T1 and the second time period T2 do not overlap with each other. That is, the light-emitting diode 110 is not driven by the first driving circuit 120 and the second driving circuit 130 at the same time. Specifically, operation 202 and operation 204 can be repeatedly and alternatively provided, so that the stress of electronic component(s) (e.g., the first driving transistor 122) in the first driving circuit 120 and electronic component(s) (e.g., the second driving transistor 132) in the second driving circuit 130 can be properly released since the first driving circuit 120 can have a rest during a time interval (or a time frame, as often used in the display field) when the light-emitting diode 110 is driven by the second driving circuit 130, and vice versa. As a result, the reliability of the light emitting diode driving circuit 100, 100A, 100B, 100C, 100D or 100E can be enhanced. In these embodiments, the first scan line SC1 and the second scan line SC2 can be separated from each other, and the first data line DA1 and the second data line DA2 also can be separated from each other (as exemplified in FIG. 1A).

Reference is made to FIGS. 1C and 3B. FIG. 3B is a first operation set 200a for the driving method 200 according to some embodiment of the present disclosure. In some embodiments, the first operation set 200a is provided during the first time period T1. The first operation set 200a includes operations 2022, 2024, and 2026. A scan-on voltage is provided to the first driving circuit 120 and the second driving circuit 130 in operation 2022 to enable a control of the first driving transistor 122 in the first driving circuit 120 and to enable a control of the second driving transistor 132 in the second driving circuit 130. The “control of” herein means gate-to-source voltages of the first driving transistor 122 and the second driving transistor 132 are allowed to be tuned by the voltages applied from the first data line DA1 and the second data line DA2 respectively, so as to control a current flowing from the drain terminal to the source terminal of the first driving transistor 122 and a current flowing from the drain terminal to the source terminal of the second driving transistor 132. A data-on voltage is provided to the first driving transistor 120 in operation 2024 to control the light-emitting diode 110 by the first driving circuit 120. A voltage level of the scan-on voltage is determined such that a carrier channel (e.g., an electron channel for an n-channel switching transistor) is formed between source and drain electrodes of the switching transistor under consideration. The meaning of the word “enable” can also refer to forming a carrier channel between source and drain electrodes of the transistor under consideration. A data-off voltage is provided to the second driving transistor 132 in operation 2026 to disable the second driving circuit 132 from controlling the light-emitting diode 110. In operation 2026, a value of the data-off voltage is determined such that a gate-to-source voltage of the second driving transistor 132 is less than or equal to a threshold voltage of the second driving transistor 132, so that a carrier channel will not be formed between source and drain electrodes of the second driving transistor 132. In operation 2024, a value of the data-on voltage is determined such that a gate-to-source voltage of the first driving transistor 122 is greater than a threshold voltage of the first driving transistor 122.

Reference is made to FIGS. 1C and 3C. FIG. 3C is a second operation set 200b for the driving method 200 according to some embodiments of the present disclosure. In some embodiments, the second operation set 200b is provided during the second time period T2. The second operation set 200b includes operations 2042, 2044, and 2046. A scan-on voltage is provided to the first driving circuit 120 and the second driving circuit 130 in operation 2042 to enable the control of the first driving transistor 122 in the first driving circuit 120 and to enable the control of the second driving transistor 132 in the second driving circuit 130. A data-off voltage is provided to the first driving transistor 122 in operation 2044 to disable the first driving circuit 120 from controlling the light-emitting diode 110. A data-on voltage is provided to the second driving transistor 132 in operation 2046 to control the light-emitting diode 110 by the second driving circuit 130. In operation 2044, a value of the data-off voltage is determined such that a gate-to-source voltage of the first driving transistor 122 is less than or equal to the threshold voltage of the first driving transistor 122. In operation 2046, a value of the data-on voltage is determined such that a gate-to-source voltage of the second driving transistor 132 is greater than a threshold voltage of the second driving transistor 132.

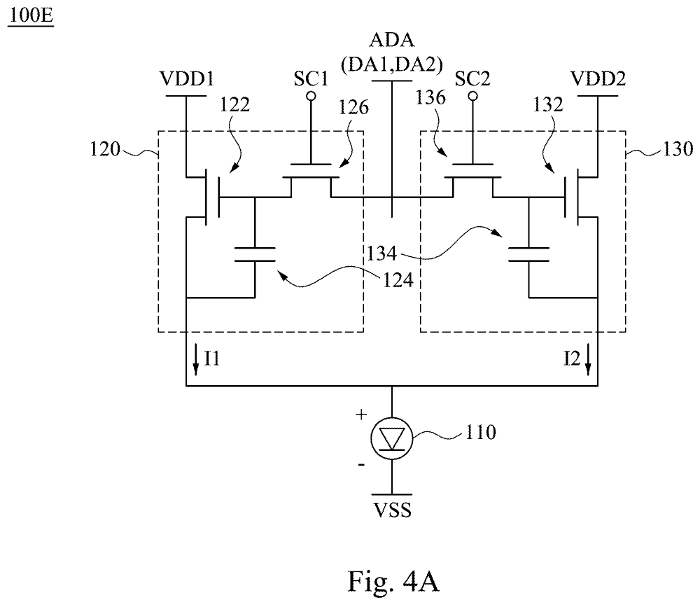

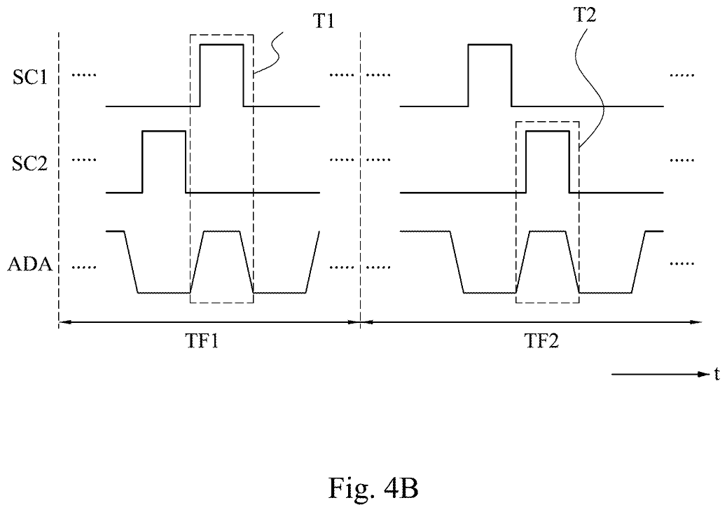

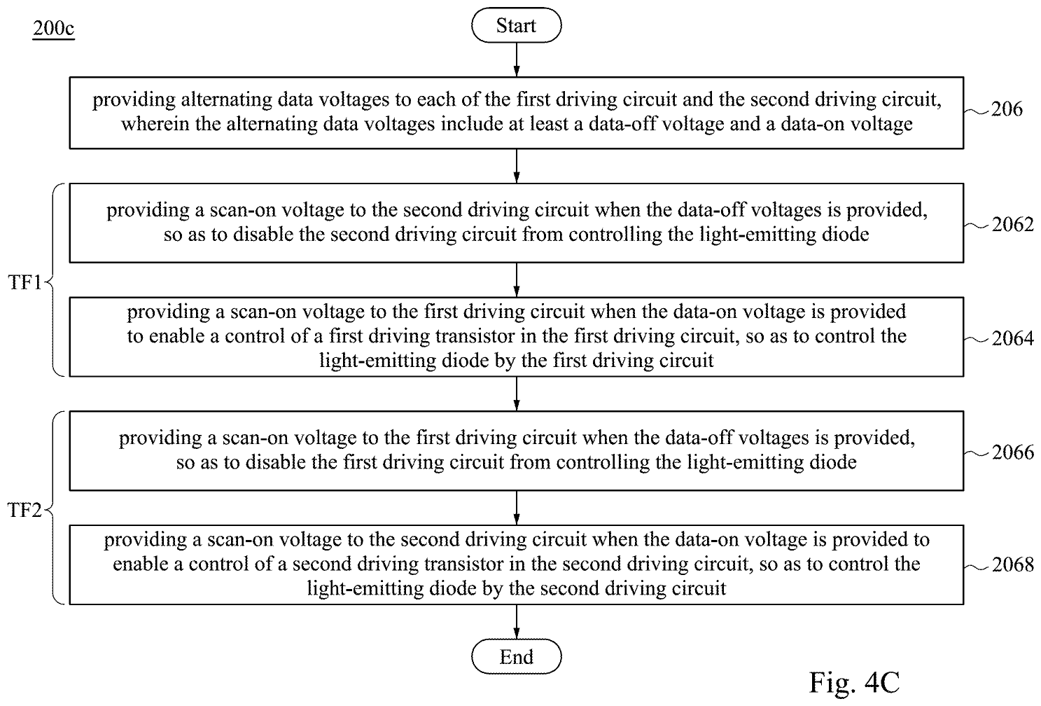

Reference is made to FIGS. 4A, 4B and 4C. FIG. 4A is a schematic diagram of a light-emitting diode driving circuit 100E according to some embodiments of the present disclosure. FIG. 4B is a voltage versus time (denoted by t in a horizontal direction) diagram of the light-emitting diode driving circuit 100E according to some embodiments of the present disclosure. FIG. 4C is a third operation set 200c for the driving method 200 according to some embodiments of the present disclosure. According to some embodiments, the first data line DA1 and the second data line DA2 are connected to a junction to save space for the circuit layout. In these embodiments, operations can be performed as follows. An operation 206 is performed with alternating data voltages ADA provided to each of the first driving circuit 120 and the second driving circuit 130 simultaneously (i.e., the alternating data voltages ADA are applied to both the first data line DA1 and the second data line DA2). The alternating data voltages ADA include at least a data-off voltage (e.g., a lower-level voltage as drawn in FIG. 4B) and a data-on voltage (e.g., a higher-level voltage as drawn in FIG. 4B). In the embodiments as shown in FIG. 4B, the alternating data voltages ADA are a series of data-off voltages and data-on voltages which are alternated and repeated with respect to one another.

During a first time frame TF1 which includes the first time period T1, an operation 2062 is performed during the first time frame TF1 in which a scan-on voltage is provided to the second driving circuit 130 when the data-off voltage is provided, so as to disable the second driving circuit 130 from controlling the light-emitting diode 110 in a time period within the first time frame TF1 that is different from the first time period T1. Besides, an operation 2064 is performed in which a scan-on voltage is provided to the first driving circuit 120 when the data-on voltage is provided. The operation 2064 thus enables a control of the first driving transistor 122 in the first driving circuit 120, so as to control the light-emitting diode 110 by the first driving circuit 120 during the first time period T1.

During a second time frame TF2 which includes the second time period T2, an operation 2066 is performed during the second time frame TF2 in which a scan-on voltage is provide to the first driving circuit 120 when the data-off voltages is provided, so as to disable the first driving circuit 120 from controlling the light-emitting diode 110 in a time period within the second time frame TF2 that is different from the second time period T2. Besides, an operation 2068 is performed in which a scan-on voltage is provided to the second driving circuit 130 when the data-on voltage is provided. The operation 2068 thus enables a control of the second driving transistor 132 in the second driving circuit 130, so as to control the light-emitting diode 110 by the second driving circuit 130. It should be noted that, in the above embodiments, the first time frame TF1 and the second time frame TF2 do not overlap with each other.

In the above embodiments as illustrated by FIGS. 4A, 4B and 4C, the data-off voltage and the data-on voltage are selected by the following conditions. The data-off voltage provided during the first time frame TF1 is determined such that a gate-to-source voltage of the second driving transistor 132 is less than or equal to a threshold voltage of the second driving transistor 132. The data-on voltage provided during the first time frame TF1 is determined such that a gate-to-source voltage of the first driving transistor 122 is greater than a threshold voltage of the first driving transistor 122. The data-off voltage provided during the second time frame TF2 is determined such that a gate-to-source voltage of the first driving transistor 122 is less than or equal to the threshold voltage of the first driving transistor 122. The data-on voltage provided during the second time frame TF2 is determined such that a gate-to-source voltage of the second driving transistor 132 is greater than the threshold voltage of the second driving transistor 132.

In some other embodiments, the first scan line SC1 and the second scan line SC2 can be connected to a junction and will not be described herein in details.

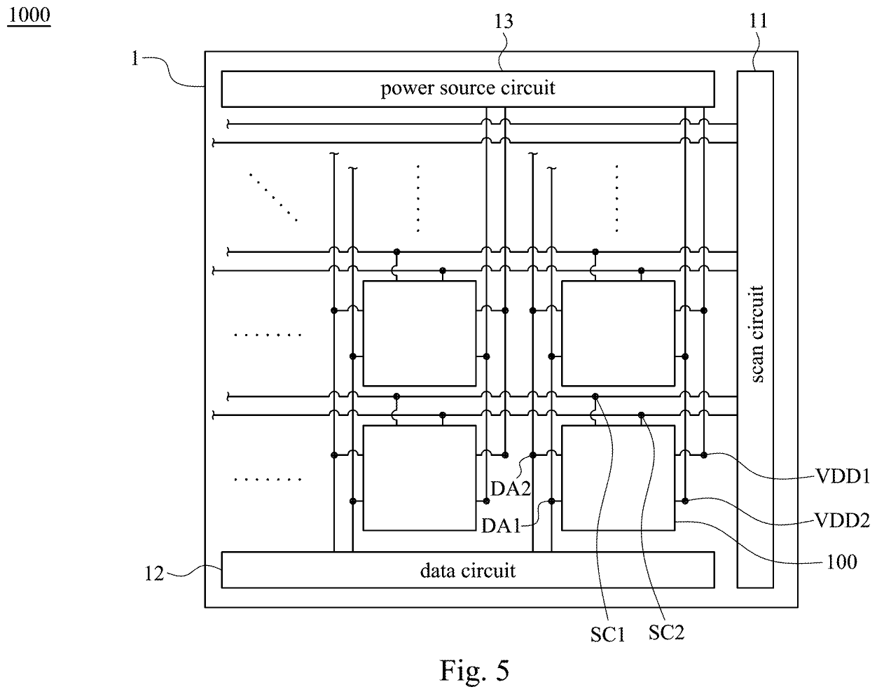

Reference is made to FIG. 5, FIGS. 1A, 1B, 1D, 1E, 2 and 4A. FIG. 5 is a schematic top view of a light-emitting diode display 1000 according to some embodiments of the present disclosure. In some embodiments, the light-emitting diode display 1000 includes a substrate 1 and a plurality of light-emitting diode driving circuits 100. Although FIG. 5 only indicates the light-emitting diode driving circuit 100, it is only for an exemplification. Other kinds of light-emitting diode driving circuits (e.g., the light-emitting diode driving circuits 100A, 100B, 100C, 100D, 100E, combinations thereof, or the like) can be present in embodiments as illustrated by FIG. 5 and should not be limited thereto. Each of square blocks in FIG. 5 represents a light-emitting diode driving circuit 100 or, equivalently, one pixel. For clarity, the operations described in FIGS. 3A to 3C and FIG. 4C are operated within said one pixel circuit. The light-emitting diode driving circuits 100 are present on the substrate 1. The light-emitting diode display 1000 can further include a scan circuit 11, a data circuit 12, and a power source circuit 13. The scan circuit 11 is configured to provide scan voltages to scan lines (e.g., the scan line SC1 and the scan line SC2 of the light-emitting diode driving circuit 100, but should not be limited thereto). The data circuit 12 is configured to provide data voltages to data lines (e.g., the data line DA1 and the data line DA2 of the light-emitting diode driving circuit 100, but should not be limited thereto). The power source circuit 13 acts as driving voltage sources to provide driving voltages to the light-emitting diode driving circuits 100. For example, the power source circuit 13 can act as the first driving voltage source VDD1 to provide the first driving voltage to the first driving transistor 122 of the light-emitting diode driving circuit 100, and also act as the second driving voltage source VDD2 to provide the second driving voltage to the second driving transistor 132 of the light-emitting diode driving circuit 100.

In summary, a light-emitting diode driving circuit with two individual driving circuits electrically and separately connected to a light-emitting diode and driving the light-emitting diode alternatively is provided in the embodiments of the present disclosure. The arrangement of the electrical connection can release stresses in both two driving circuits during operations of driving the light-emitting diode and thus can enhance the reliability of the whole light-emitting diode driving circuit.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A light-emitting diode driving circuit, comprising:
a light emitting diode;
a first driving circuit configured to provide a first driving current to the light-emitting diode during a first time period; and
a second driving circuit configured to provide a second driving current to the light-emitting diode during a second time period,
wherein the first driving circuit and the second driving circuit are electrically and separately connected to one end of the light-emitting diode, and the first time period does not overlap with the second time period.

2. The light-emitting diode driving circuit of claim 1, wherein the light-emitting diode has an anode and a cathode, the anode of the light-emitting diode is configured to receive the first driving current and the second driving current, and the cathode is connected to a low voltage source.

3. The light-emitting diode driving circuit of claim 1, wherein the light-emitting diode has an anode and a cathode, and the cathode is electrically and separately connected to the first driving circuit and the second driving circuit.

4. The light-emitting diode driving circuit of claim 1, wherein
the first driving circuit comprises:
a first driving transistor having a gate terminal, a source terminal, and a drain terminal, the drain terminal configured to receive a first driving voltage from a first driving voltage source; and
the second driving circuit comprises:
a second driving transistor having a gate terminal, a source terminal, and a drain terminal, the drain terminal configured to receive a second driving voltage from a second driving voltage source.

5. The light-emitting diode driving circuit of claim 4, wherein the light-emitting diode has an anode and a cathode, the cathode is connected to a low voltage source, and the anode is connected to the source terminal of the first driving transistor and the source terminal of the second driving transistor.

6. The light-emitting diode driving circuit of claim 4, wherein the light-emitting diode has an anode and a cathode, the anode is connected to the first driving voltage source and the second driving voltage source, and the cathode is connected to the drain terminal of the first driving transistor and the drain terminal of the second driving transistor.

7. The light-emitting diode driving circuit of claim 4, further comprising:
a first storage capacitor having two ends, wherein one of the two ends of the first storage capacitor is connected to the gate terminal of the first driving transistor, and another of the two ends is connected to the source terminal of the first driving transistor, a first reference voltage, or the first driving voltage source; and
a second storage capacitor having two ends, wherein one of the two ends of the second storage capacitor is connected to the gate terminal of the second driving transistor, and another of the two ends is connected to the source terminal of the second driving transistor, a second reference voltage, or the second driving voltage source.

8. The light-emitting diode driving circuit of claim 7, further comprising:
a first switching transistor having a gate terminal connected to a first scan line, a drain terminal connected to a first data line, and a source terminal connected to said one of the two ends of the first storage capacitor and the gate terminal of the first driving transistor; and
a second switching transistor having a gate terminal connected to a second scan line, a drain terminal connected to a second data line, and a source terminal connected to said one of the two ends of the second storage capacitor and the gate terminal of the second driving transistor.

9. The light-emitting diode driving circuit of claim 8, wherein the first scan line and the second scan line are separated from each other, and the first data line and the second data line are separated from each other.

10. The light-emitting diode driving circuit of claim 8, wherein the first scan line and the second scan line are connected to a junction or separated from each other.

11. The light-emitting diode driving circuit of claim 8, wherein the first data line and the second data line are connected to a junction or separated from each other.

12. A driving method for a light-emitting diode driving circuit, comprising:
providing a first driving current to a light-emitting diode by a first driving circuit during a first time period;
providing a second driving current to the light-emitting diode by a second driving circuit during a second time period, wherein the first driving circuit and the second driving circuit are two individual driving circuits, and the first time period and the second time period do not overlap with each other.

13. The driving method of claim 12, wherein during a first time period, the driving method further comprises:
providing a scan-on voltage to the first driving circuit and the second driving circuit to enable a control of a first driving transistor in the first driving circuit and to enable a control of a second driving transistor in the second driving circuit;
providing a data-on voltage to the first driving transistor, and controlling the light-emitting diode by the first driving circuit; and
providing a data-off voltage to the second driving transistor, and disabling the second driving circuit from controlling the light-emitting diode.

14. The driving method of claim 13, wherein
a value of the data-off voltage is determined such that a gate-to-source voltage of the second driving transistor is less than or equal to a threshold voltage of the second driving transistor; and
a value of the data-on voltage is determined such that a gate-to-source voltage of the first driving transistor is greater than a threshold voltage of the first driving transistor.

15. The driving method of claim 12, wherein during a second time period, the driving method further comprises:
providing a scan-on voltage to the first driving circuit and the second driving circuit to enable a control of a first driving transistor in the first driving circuit and to enable a control of a second driving transistor in the second driving circuit;
providing a data-off voltage to the first driving transistor, and disabling the first driving circuit from controlling the light-emitting diode; and
providing a data-on voltage to the second driving transistor, and controlling the light-emitting diode by the second driving circuit.

16. The driving method of claim 15, wherein
a value of the data-off voltage is determined such that a gate-to-source voltage of the first driving transistor is less than or equal to a threshold voltage of the first driving transistor; and
a value of the data-on voltage is determined such that a gate-to-source voltage of the second driving transistor is greater than a threshold voltage of the second driving transistor.

17. The driving method of claim 12, further comprising:
providing alternating data voltages to each of the first driving circuit and the second driving circuit, wherein the alternating data voltages comprise at least a data-off voltage and a data-on voltage;
during a first time frame, the method further comprising:
providing a scan-on voltage to the first driving circuit when the data-on voltage is provided to enable a control of a first driving transistor in the first driving circuit, so as to control the light-emitting diode by the first driving circuit; and
providing a scan-on voltage to the second driving circuit when the data-off voltage is provided, so as to disable the second driving circuit from controlling the light-emitting diode; and
during a second time frame, the method further comprising:
providing a scan-on voltage to the second driving circuit when the data-on voltage is provided to enable a control of a second driving transistor in the second driving circuit, so as to control the light-emitting diode by the second driving circuit;
providing a scan-on voltage to the first driving circuit when the data-off voltages is provided, so as to disable the first driving circuit from controlling the light-emitting diode;
wherein the first time frame and the second time frame do not overlap with each other.

18. The driving method of claim 17, wherein
the data-off voltage provided during the first time frame is determined such that a gate-to-source voltage of the second driving transistor is less than or equal to a threshold voltage of the second driving transistor;
the data-on voltage provided during the first time frame is determined such that a gate-to-source voltage of the first driving transistor is greater than a threshold voltage of the first driving transistor;
the data-off voltage provided during the second time frame is determined such that a gate-to-source voltage of the first driving transistor is less than or equal to the threshold voltage of the first driving transistor; and
the data-on voltage provided during the second time frame is determined such that a gate-to-source voltage of the second driving transistor is greater than the threshold voltage of the second driving transistor.

19. The driving method of claim 12, wherein said providing the first driving current to the light-emitting diode by the first driving circuit and said providing the second driving current to the light-emitting diode by the second driving circuit are repeated alternatively.

20. A light-emitting diode display, comprising:
a substrate; and
a plurality of the light-emitting diode driving circuit of claim 1 present on the substrate.
